(19) United States
(12) Patent Application Publication
(10) Pub. No.: US 2004/0087676 A1
(43) Pub. Date: May 6, 2004

(54) Film formation method

(75) Inventor: Tomoyuki Okuyama, Chino-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/660,554

(22) Filed: Sep. 12, 2003

(30) Foreign Application Priority Data
Sep. 13, 2002 (JP) 2002-268614

(51) Int. Cl. C08J 3/28; C08G 61/00

(52) U.S. Cl. 522/1; 528/396

(57) ABSTRACT

The invention provides a film formation method in which a film containing an acene compound can be formed by a liquid-phase process. A film formation method includes: applying light and/or heat to an acene compound to cause a cycloaddition reaction to produce a cyclized compound which is soluble in a solvent, placing a liquid layer containing the cyclized compound and a solvent which can dissolve the cyclized compound on a substrate, and applying light and/or heat to the liquid layer to produce a solid composed of the acene compound.

### BACKGROUND OF THE INVENTION

1. Field of Invention

The present invention relates to film formation methods using cyclized compounds of acenes.

2. Description of Related Art

The related art uses acene compounds, such as pentacene, as organic semiconductor materials.

An acene compound is a polycyclic compound having a structure in which benzene nuclei are linearly condensed. Acene compounds with a small number of rings, such as bicyclic naphthalene and tricyclic anthracene, are soluble in solvents.

On the other hand, in view of properties of semiconductor materials, acene compounds with a large number of rings are preferred. However, acene compounds with four or more rings have low solubility in solvents. Consequently, it is difficult to form films by a liquid-phase process using such acene compounds.

The related art is disclosed in A. R. Brown et al., J. Applied Physics (J. Appl. Phys.), Vol. 79, No. 4, Feb. 15, 1996, pp 2136-2138 (hereinafter “Brown”).

For example, Brown discloses that a compound produced by a [4+2] cycloaddition reaction of tetrachlorobenzene with pentacene is soluble in solvents, and also discloses a method for forming a film by a spin-coating method using the compound.

### SUMMARY OF THE INVENTION

However, in this method, tetrachlorobenzene must be removed by heating after the film is formed.

If it is possible to produce soluble molecules particularly composed of only acene molecules which can form a laminated structure of rings without incorporating molecules to be distilled off by heating, a laminated structure of molecules is easily formed, and considerable improvement in semiconductor properties is expected.

In the present specification, a cycloaddition reaction represented by reaction formula (1) below is referred to as a [4+4] cycloaddition reaction, and a cyclized compound produced by the reaction is referred to as a [4+4] cyclized compound. A cycloaddition reaction represented by reaction formula (2) below is referred to as a [4+2] cycloaddition reaction, and a cyclized compound produced by the reaction is referred to as a [4+2] cyclized compound.

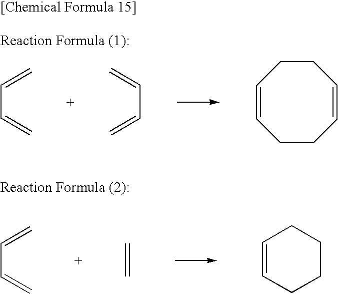

The present invention addresses such circumstances, and provides a film formation method in which a film containing an acene compound is formed by a liquid-phase process, a raw material liquid used in the method, a solution, a cyclized compound, a method for forming an organic semiconductor film using the film formation method, and a method for fabricating a semiconductor device using the method for forming the organic semiconductor film.

In order to address or solve the above, a first film formation method of the present invention includes: applying light and/or heat to a first compound represented by general formula (I) below and a second compound represented by general formula (II) below to produce a cyclized compound by way of cycloaddition of the first compound and the second compound, placing a liquid layer containing the cyclized compound and a solvent which can dissolve the cyclized compound on a substrate, and applying light and/or heat to the liquid layer to produce a solid containing the first compound and the second compound.

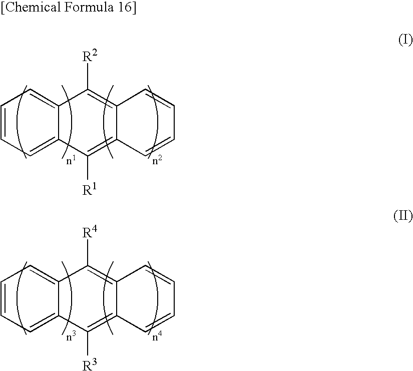

(In the formulae, R¹, R², R³, and R⁴, which maybe the same or different, each have an atomic number of 1 to 18, and each contain at least one atom or moiety selected from a group A below, and the hydrogen atoms in the benzene nuclei may be substituted. The group A includes a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety. Each of n¹, n², n³, and n⁴ is an integer of 0 or more, and at least one of n¹+n² and n³+n⁴ is 2 or more.)

When light and/or heat are applied to the first compound represented by general formula (I) and the second compound represented by general formula (II), a [4+4] cycloaddition reaction represented by reaction formula (3) below and/or a [4+2] cycloaddition reaction represented by reaction formula (4) take place, and a [4+4] cyclized compound represented by general formula (III) and/or a [4+2] cyclized compound represented by general formula (VI) are produced. When light is applied to the first compound and the second compound, the [4+4] cycloaddition reaction takes place, and when heat is applied, the [4+2] cycloaddition reaction takes place. When light and heat are applied, a mixture of the [4+4] cyclized compound and the [4+2] cyclized compound is produced.

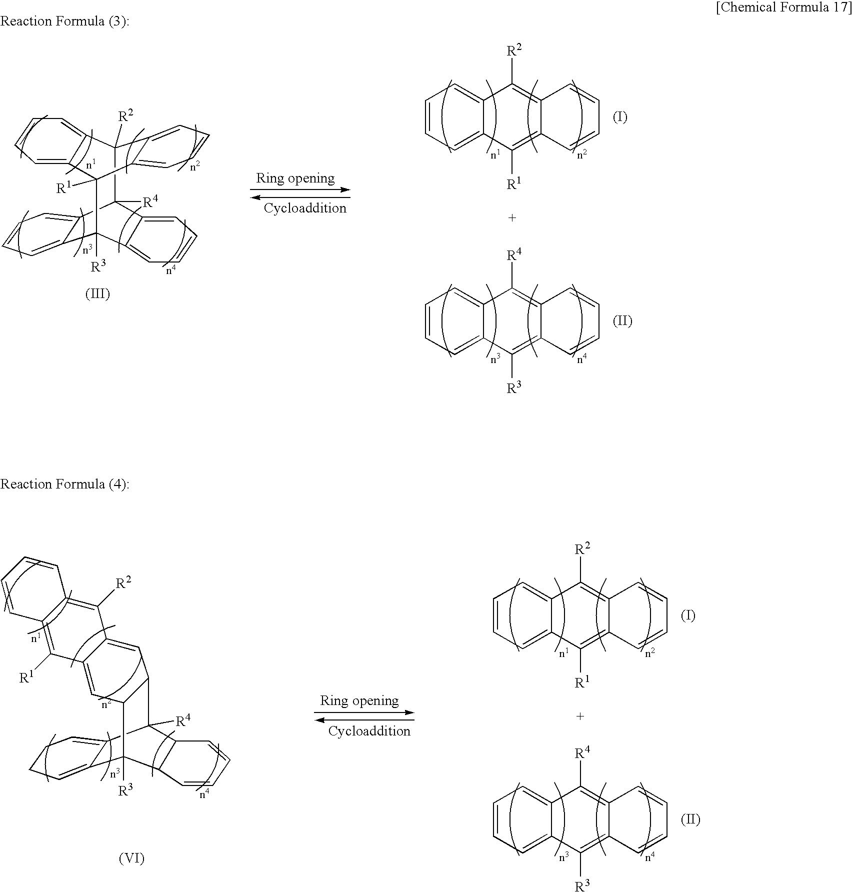

(In the formulae, R¹, R², R³, R⁴, n¹, n², n³, and n⁴ are the same as those in general formulae (I) and (II), and the hydrogen atoms in the benzene nuclei may be substituted.)

Each of the [4+4] cyclized compound represented by general formula (III) and the [4+2] cyclized compound represented by general formula (VI) is soluble in a solvent, and the ring opening reactions represented by reaction formulae (3) and (4) are caused by the action of light and/or heat, and the first compound and the second compound are thereby produced.

At least one of the first compound and the second compound is an acene compound in which at least three benzene nuclei are linearly condensed, and thereby semiconductor properties are exhibited.

The first compound and the second compound may be the same.

Consequently, the cyclized compounds which are soluble in the solvent are produced by applying light and/or heat to the first compound and the second compound, and after the liquid layer is formed on the substrate using a solution in which the cyclized compounds are dissolved in the solvent, light and/or heat are applied to the liquid layer to cause the ring opening reactions, and the solvent is removed. Thereby, the solid layer containing an acene compound having semiconductor properties is obtained.

In accordance with the film formation method of the present invention, a film containing an acene compound having semiconductor properties can be formed by a liquid-phase process.

In the film formation method of the present invention, since it is possible to form a film without using an unnecessary compound for forming the film, impurities are prevented from being contained in the film, and an organic semiconductor layer with a high purity can be formed.

It is also possible to form the solid layer of the acene compound via the soluble molecules composed of only acene molecules which can form a laminated structure of rings without incorporating molecules to be distilled off by heating after the film formation. Consequently, the laminated structure of molecules is easily formed, and the semiconductor properties can be remarkably enhanced.

The film formed by the method of the present invention contains the first compound and the second compound, which are changed to a cyclized compound soluble in a solvent by a cycloaddition reaction by the action of light and/or heat. Therefore, by partially applying light and/or heat to the film, the portions of the film applied with light and/or heat become selectively soluble in a solvent. Consequently, it is possible to perform patterning on the film using such a feature.

In particular, when the first compound and the second compound are insoluble in a solvent, since the resultant film is not easily dissolved in a solvent, it is possible to easily form another film thereon by a liquid-phase process using a solvent.

In the film formation method of the present invention, either the [4+4] cyclized compound represented by general formula (III) or the [4+2] cyclized compound represented by general formula (VI) may be used. Preferably, the [4+4] cyclized compound represented by general formula (III) is used because of enhanced orientation of the film. The reason for this is considered to be due to a difference in the molecular structure of the cyclized compound.

The present invention also provides a raw material liquid containing the first compound, the second compound, and a solvent.

By applying light and/or heat to the raw material liquid, it is possible to easily prepare a solution containing a cyclized compound produced by the cycloaddition of the first compound and the second compound and a solvent. By applying light and/or heat to the solution, the first compound and the second compound can be produced, and therefore, the raw material liquid is effective in forming a film containing the first compound and the second compound by a liquid-phase process.

In the raw material liquid, organic semiconductor materials can be suitably used as the first and second compounds, and the raw material liquid is effective in forming a film composed of the organic semiconductor materials by a liquid-phase process. Consequently, even if the organic semiconductor materials are insoluble in a solvent, a film containing the organic semiconductor materials can be formed by a liquid-phase process.

The present invention also provides a solution containing a cyclized compound produced by the cycloaddition of the first compound and the second compound and a solvent which can dissolve the cyclized compound.

The solution can be applied onto a substrate by a spin-coating method, an ink-jet method, or the like. The cyclized compound dissolved in the solvent produces the first compound and the second compound by the application of light and/or heat. Consequently, the solution is effective in forming a film containing the first compound and the second compound by a liquid-phase process.

In the solution of the present invention, organic semiconductor materials can be suitably used as the first and second compounds, and the solution is effective in forming a film composed of the organic semiconductor materials by a liquid-phase process.

In the solution of the present invention, either the [4+4] cyclized compound represented by general formula (III) or the [4+2] cyclized compound represented by general formula (VI) may be used. Preferably, the [4+4] cyclized compound represented by general formula (III) is used because of improved orientation of the film.

The present invention also provides a cyclized compound produced by the cycloaddition of the first compound and the second compound by the action of light and/or heat.

The cyclized compound is soluble in a solvent and reverts to an acene compound by the action of light and/or heat. Therefore, even if the acene compound is insoluble in a solvent, a film can be formed by a liquid-phase process by way of the cyclized compound.

In particular, acene compounds which have favorable semiconductor properties have a large number of rings and low solubility in solvents. Consequently, by using a cyclized compound produced by cycloadditions of such acene compounds having a large number of rings, a film composed of an organic semiconductor material having excellent semiconductor properties can be formed by a liquid-phase process.

In particular, the [4+4] cyclized compound represented by general formula (III) is preferred in view of formation of a film with enhanced orientation.

The present invention also provides a method for forming an organic semiconductor film using the film formation method of the present invention.

By using an acene compound having organic semiconductor properties as at least one of the first compound and the second compound, the organic semiconductor film can be formed by a liquid-phase process. Such a method for forming an organic semiconductor film is useful in fabricating a semiconductor device.

The present invention also provides a method for fabricating a semiconductor device using the organic semiconductor film formation method of the present invention.

In order to address or solve the above, a second film formation method of the present invention includes: applying light and/or heat to a fourth compound represented by general formula (IV) below to produce a cyclized compound by way of intramolecular cycloaddition of two types of aromatic moieties in the fourth compound, placing a liquid layer containing the cyclized compound and a solvent which can dissolve the cyclized compound on a substrate, and applying light and/or heat to the liquid layer to produce a solid containing the fourth compound.

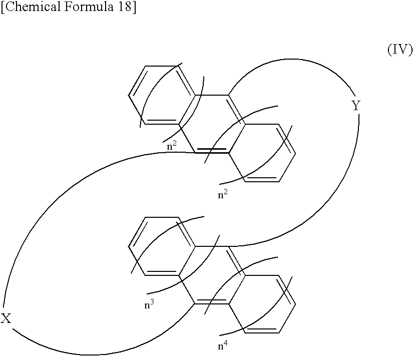

(In the formula, X and Y, which may be the same or different, each have an atomic number of 2 to 18, and each contain at least one atom or moiety selected from a group A below, and the hydrogen atoms in the benzene nuclei may be substituted. The group A includes a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety. Each of n¹, n², n³, and n⁴ is an integer of 0 or more, and at least one of n¹+n² and n³+n⁴ is 2 or more.)

When light and/or heat are applied to the fourth compound represented by general formula (IV), a [4+4] cycloaddition reaction represented by reaction formula (5) below and/or a [4+2] cycloaddition reaction represented by reaction formula (6) take place, and a [4+4] cyclized compound represented by general formula (V) and/or a [4+2] cyclized compound represented by general formula (VII) are produced. When light is applied to the fourth compound, the [4+4] cycloaddition reaction takes place, and when heat is applied, the [4+2] cycloaddition reaction takes place. When light and heat are applied, a mixture of the [4+4] cyclized compound and the [4+2] cyclized compound is produced.

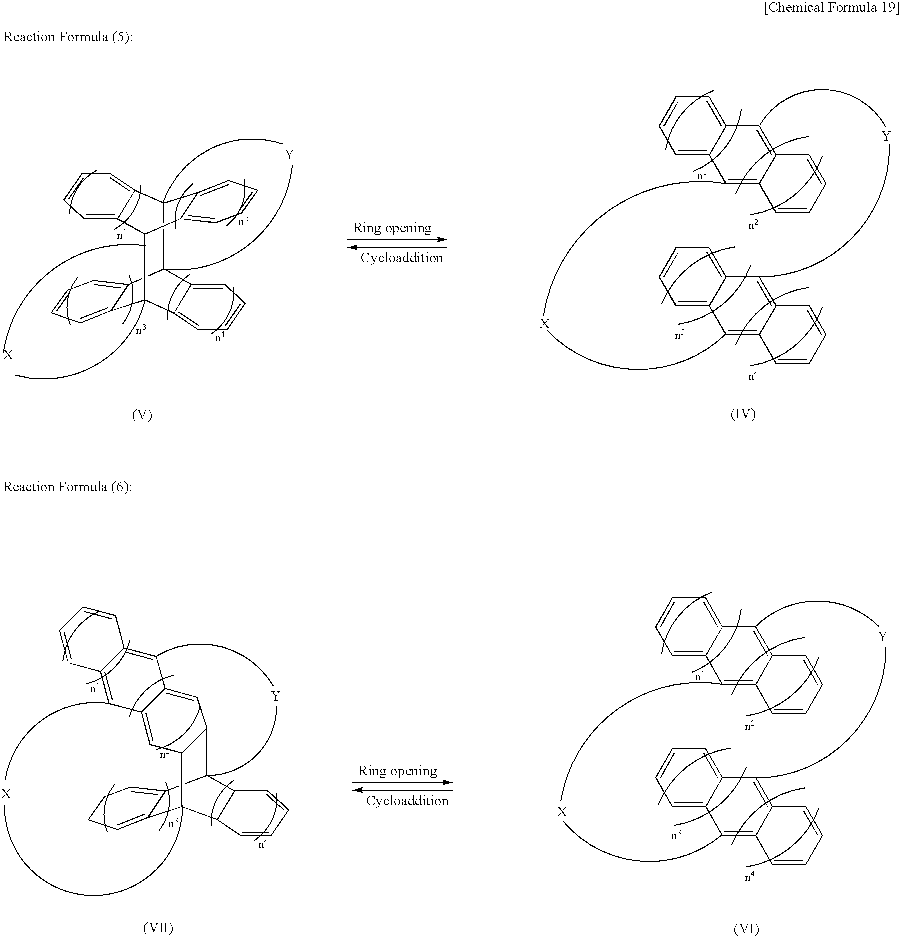

(In the formulae, X, Y, n¹, n², n³, and n⁴ are the same as those in general formula (IV), and the hydrogen atoms in the benzene nuclei may be substituted.)

Each of the [4+4] cyclized compound represented by general formula (V) and the [4+2] cyclized compound represented by general formula (VII) is soluble in a solvent, and the ring opening reactions represented by reaction formulae (5) and (6) are caused by the action of light and/or heat, and the fourth compound is thereby produced.

The fourth compound is a crosslinked compound of two types of condensed ring aromatic moieties, and since at least one of the aromatic moieties is an acene moiety in which at least three benzene nuclei are linearly condensed, the fourth compound has the semiconductor properties. The two types of aromatic moieties of the fourth compound may be the same.

Consequently, the cyclized compound which is soluble in the solvent is produced by applying light and/or heat to the fourth compound, and after the liquid layer is formed on the substrate using a solution in which the cyclized compound is dissolved in the solvent, light and/or heat are applied to the liquid layer to cause the ring opening reaction, and the solvent is removed. Thereby, the solid layer containing an acene compound having semiconductor properties, i.e., the fourth compound, is obtained.

In accordance with the film formation method of the present invention, a film containing an acene compound having semiconductor properties can be formed by a liquid-phase process.

In the film formation method of the present invention, since it is possible to form a film without using an unnecessary compound for forming the film, impurities are prevented from being contained in the film, and an organic semiconductor layer with a high purity can be formed.

It is also possible to form the solid layer of the acene compound via the soluble molecules composed of only acene molecules which can form a laminated structure of rings without incorporating molecules to be distilled off by heating after the film formation. Consequently, the laminated structure of molecules is easily formed, and the semiconductor properties can be remarkably enhanced.

The film formed by the method of the present invention contains the fourth compound, which is changed to a cyclized compound soluble in a solvent by an intramolecular cycloaddition reaction by the action of light and/or heat. Therefore, by partially applying light and/or heat to the film, the portions of the film applied with light and/or heat become selectively soluble in a solvent. Consequently, it is possible to perform patterning on the film using such a feature.

In particular, when the acene compound produced by the ring-opening reaction of the fourth compound is insoluble in a solvent, since the resultant film is not easily dissolved in a solvent, it is possible to easily form another film thereon by a liquid-phase process using a solvent.

In the film formation method of the present invention, either the [4+4] cyclized compound represented by general formula (V) or the [4+2] cyclized compound represented by general formula (VII) may be used. Preferably, the [4+4] cyclized compound represented by general formula (V) is used because of improved orientation of the film. The reason for this is considered to be due to a difference in the molecular structure of the cyclized compound.

The present invention also provides a raw material liquid containing the fourth compound and a solvent.

By applying light and/or heat to the raw material liquid, it is possible to easily prepare a solution containing a cyclized compound produced by the cycloaddition of the fourth compound and a solvent. By applying light and/or heat to the solution, the fourth compound can be produced, and therefore, the solution is effective in forming a film containing the fourth compound by a liquid-phase process.

The raw material liquid of the present invention is particularly effective in forming a film composed of an organic semiconductor material by a liquid-phase process. Even if the organic semiconductor material is insoluble in a solvent, a film containing the organic semiconductor material can be formed by a liquid-phase process.

The present invention also provides a solution containing a cyclized compound produced by the cycloaddition of the fourth compound and a solvent which can dissolve the cyclized compound.

Such a solution can be applied onto a substrate by a spin-coating method, an ink-jet method, or the like. The cyclized compound dissolved in the solvent produces the fourth compound by the application of light and/or heat. Consequently, the solution is effective in forming a film containing the fourth compound by a liquid-phase process.

The solution of the present invention is particularly effective in forming a film composed of an organic semiconductor material by a liquid-phase process.

In the solution of the present invention, either the [4+4] cyclized compound represented by general formula (V) or the [4+2] cyclized compound represented by general formula (VII) may be used. Preferably, the [4+4] cyclized compound represented by general formula (V) is used because of improved orientation of the film.

The present invention also provides a cyclized compound produced by the intramolecular cycloaddition of the fourth compound by the action of light and/or heat.

The cyclized compound is soluble in a solvent and reverts to the fourth compound by the action of light and/or heat. Therefore, even if the fourth compound is insoluble in a solvent, a film can be formed by a liquid-phase process by way of the cyclized compound. Accordingly, it is possible to form a film by a liquid-phase process using an acene compound having low solubility in solvents, and a film composed of an organic semiconductor material having excellent semiconductor properties can be obtained.

In particular, the [4+4] cyclized compound represented by general formula (V) is preferred in view of formation of a film with improved orientation.

The present invention also provides a method for forming an organic semiconductor film using the film formation method of the present invention.

By using a compound in which at least one of the two types of condensed ring aromatic moieties is an acene moiety having semiconductor properties as the fourth compound, an organic semiconductor film can be formed by a liquid-phase process. Such a method for forming an organic semiconductor film is useful in fabricating a semiconductor device.

The present invention also provides a method for fabricating a semiconductor device using the organic semiconductor film formation method of the present invention.

### DETAILED DESCRIPTION OF PREFERRED EMBODIMENTS

The present invention is described in more detail below.

In general formulae (I) to (VII), each of n¹, n², n³, and n⁴ is an integer of 0 or more, and at least one of n¹+n² and n³+n⁴ is 2 or more. Each of n¹+n² and n³+n⁴ is preferably 3 or more, and the upper limit of each of n¹+n² and n³+n⁴ is preferably 6 or less.

The atoms or moieties constituting the group A in general formulae (I) to (VII) are described below.

Specific examples of halogen atoms include fluorine, chlorine, bromine, and iodine.

As the alkane moiety, a substituent derived from a straight-chain or branched alkane having 1 to 18 carbon atoms by removal of at least one hydrogen atom is preferred. Examples thereof include methyl, ethyl, propyl, butyl, pentyl, hexyl, heptyl, octyl, isopropyl, isobutyl, and tert-butyl.

As the alkene moiety, a substituent derived from a straight-chain or branched alkene having 2 to 18 carbon atoms by removal of at least one hydrogen atom is preferred. Examples thereof include ethinyl, propenyl, butenyl, butadienyl, and pentadienyl.

Preferred examples of ether moieties include (—CRR′—O—CR″R′″—).

Preferred examples of acetal moieties include (—O—CH₂—O—), (—O—CHR—O—), (—O—CRR′—O—), and (—CH(OR)(OR′)).

Preferred examples of carbonyl moieties include (—CO—).

Preferred examples of amino moieties include (—NH₂), (—NHR), and (—NRR′).

Preferred examples of amide moieties include (—NRCO—).

Preferred examples of ester moieties include (—COO—).

Preferred examples of carbonate ester moieties include (—OCOO—).

Preferred examples of imide moieties include (—CONRCO—).

Preferred examples of acid anhydride moieties include (—COOCO—).

In general formulae (I) to (VII), the hydrogen atoms in the benzene nuclei, except for R¹, R², R³, R⁴, X, and Y, may be substituted. When substituted, preferably, the hydrogen atoms are preferably replaced by substituents containing atoms or moieties selected from the group A.

Specific examples of the first and second compounds represented by general formulae (I) and (II) include a compound (6,13-dibutoxypentacene) represented by structural formula (i) below.

When light is applied to 6,13-dibutoxypentacene represented by structural formula (i), a [4+4] cycloaddition reaction represented by reaction formula (7) below takes place, and a [4+4] cyclized compound represented by structural formula (ii) below is produced. When light and/or heat are applied to the [4+4] cyclized compound to cause a ring opening reaction, the [4+4] cyclized compound reverts to 6,13-dibutoxypentacene by the ring opening reaction. The 6,13-dibutoxypentacene represented by structural formula (i) can be produced according to reaction formula (8) below. The 6,13-dibutoxypentacene has semiconductor properties and is insoluble in solvents.

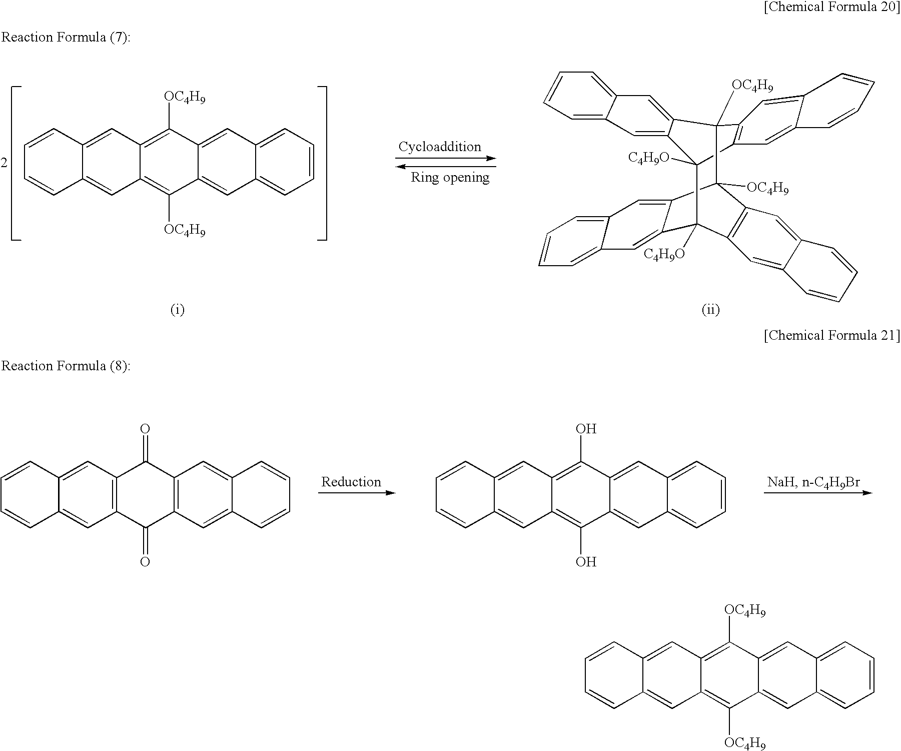

When light is applied to the first compound and the second compound to cause a cycloaddition reaction therebetween to produce a [4+4] cyclized compound represented by general formula (III), the wavelength of the light applied is preferably in a wavelength band in which light absorption by the first compound and the second compound occurs. Preferably, the wavelength of the light is set depending on the compounds used.

In order to change the [4+4] cyclized compound back to the compounds before the cycloaddition reaction by a ring opening reaction, preferably light is applied to the [4+4] cyclized compound. Alternatively, heat may be applied to the [4+4] cyclized compound. Alternatively, both light and heat may be applied to the [4+4] cyclized compound to cause a ring opening reaction.

For example, when light is applied to 6,13-dibutoxypentacene represented by structural formula (i) to cause a cycloaddition reaction to produce the [4+4] cyclized compound represented by structural formula (ii), the wavelength of the light applied is selected from the bands (approximately 320 to 410 nm and approximately 500 to 700 nm) in which light absorption by 6,13-dibutoxypentacene occurs. For example, a wavelength of 366 nm is suitable. When light is applied to the [4+4] cyclized compound represented by structural formula (ii) to cause a ring opening reaction, the wavelength of the light applied is selected from the band (approximately 250 to 320 nm) in which light absorption by the [4+4] cyclized compound occurs. For example, a wavelength of 313 nm is suitable. When heat is applied to cause a ring opening reaction, the temperature is preferably set in a range of 100° C. to 200° C.

The [4+2] cyclized compound represented by general formula (VI) is produced by applying heat to the first compound and the second compound.

In order to change the resultant [4+2] cyclized compound back to the compounds before the cycloaddition reaction by causing a ring opening reaction, heat is applied.

For example, when heat is applied to 6,13-dibutoxypentacene represented by structural formula (i) to produce the [4+2] cyclized compound, the temperature is preferably set in a range of 200° C. to 300° C. When heat is applied to the [4+2] cyclized compound to cause a ring opening reaction, the temperature is preferably set in a range of 100° C. to 200° C.

Specific examples of the fourth compound represented by general formula (IV) include compounds represented by structural formulae (iii), (v), and (vii) below. The compounds represented by structural formulae (iii), (v), and (vii) have semiconductor properties and are insoluble in solvents.

When light is applied to the compounds represented by structural formulae (iii), (v), and (vii), [4+4] cycloaddition reactions represented by reaction formulae (9), (10), and (11) below take place, and [4+4] cyclized compounds represented by structural formulae (iv), (vi), and (viii) below, respectively, are produced. When light and/or heat are applied to the [4+4] cyclized compounds to cause ring opening reactions, the [4+4] cyclized compounds are changed back to the original compounds.

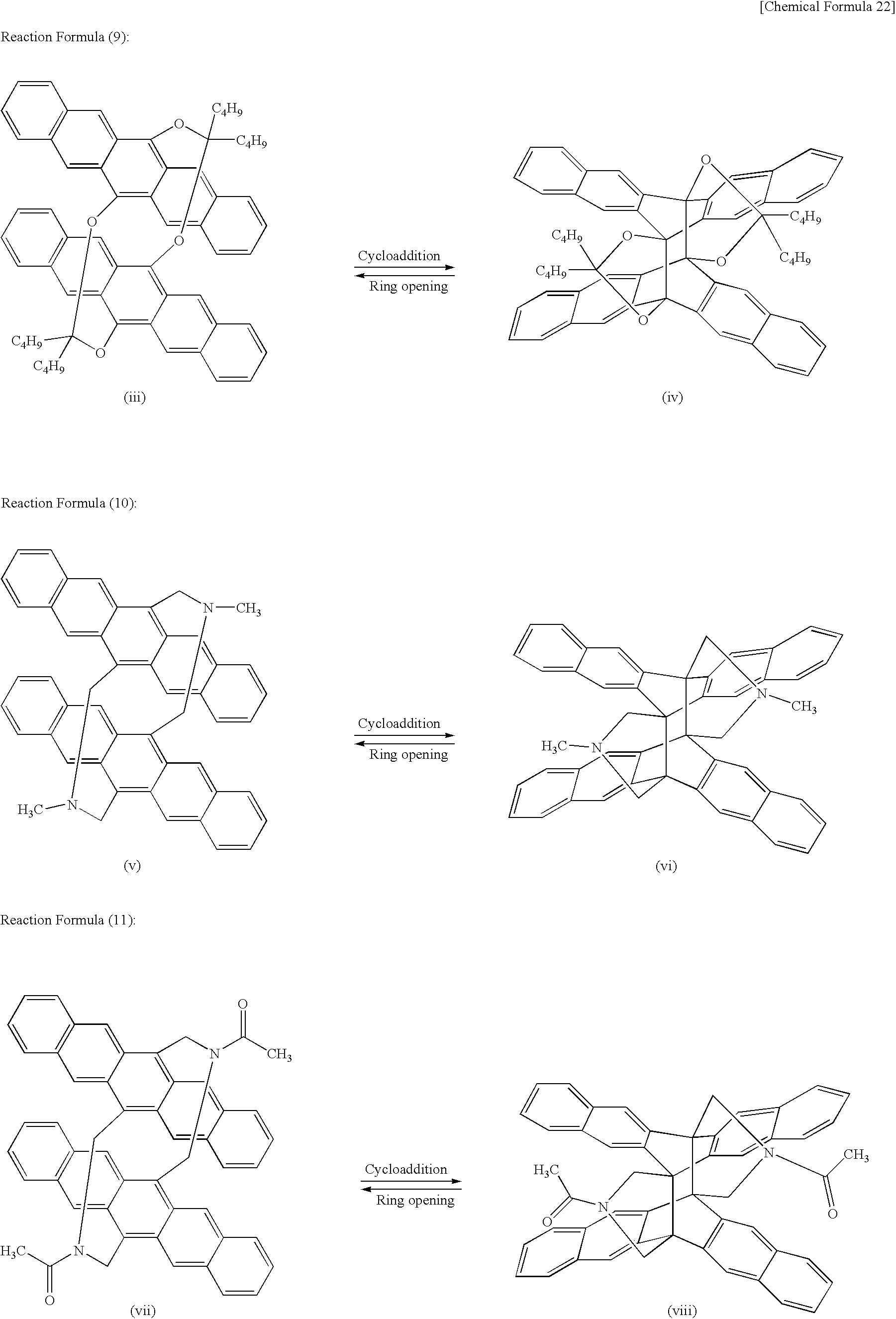

When light is applied to the fourth compound to cause a cycloaddition reaction to produce a [4+4] cyclized compound represented by general formula (V), the wavelength of the light applied is preferably in a wavelength band in which light absorption by the fourth compound occurs. Preferably, the wavelength of the light is set depending on the compound used.

In order to change the resultant [4+4] cyclized compound back to the fourth compound before the cycloaddition reaction by a ring opening reaction, preferably light is applied to the [4+4] cyclized compound. Alternatively, heat may be applied to the [4+4] cyclized compound. Alternatively, both light and heat may be applied to the [4+4] cyclized compound to cause a ring opening reaction.

For example, when light is applied to the compound represented by structural formula (iii) to produce the [4+4] cyclized compound represented by structural formula (iv), the wavelength of the light applied is selected from the bands (approximately 320 to 410 nm and approximately 500 to 700 nm) in which light absorption by the compound represented by structural formula (iii) occurs. For example, a wavelength of 366 nm is suitable. When light is applied to the [4+4] cyclized compound to cause a ring opening reaction, the wavelength of the light applied is selected from the band (approximately 250 to 320 nm) in which light absorption by the [4+4] cyclized compound occurs. For example, a wavelength of 313 nm is suitable. When heat is applied to cause a ring opening reaction, the temperature is preferably set in a range of 100° C. to 200° C.

On the other hand, the [4+2] cyclized compound represented by general formula (VII) is produced by applying heat to the fourth compound.

In order to change the resultant [4+2] cyclized compound back to the compound before the cycloaddition reaction by causing a ring opening reaction, heat is applied.

For example, when heat is applied to the compound represented by structural formula (iii) to produce a [4+2] cyclized compound, the temperature is preferably set in a range of 200° C. to 300° C. When heat is applied to the [4+2] cyclized compound to cause a ring opening reaction, the temperature is preferably set in a range of 100° C. to 200° C.

An exemplary embodiment of a film formation method of the present invention is described below.

First, a raw material liquid is prepared by dispersing or dissolving the first compound and the second compound in a solvent. The first compound and the second compound may be the same.

Alternatively, a raw material liquid is prepared by dispersing or dissolving the fourth compound in a solvent. The two types of aromatic moieties constituting the fourth compound may be the same.

Any solvent which can dissolve a cyclized compound produced by the cycloaddition of the first compound and the second compound or a cyclized compound produced by the intramolecular cycloaddition of the fourth compound may be used, and various organic solvents are preferably used. Preferred examples of solvents include propylene glycol monomethyl ether acetate, propylene glycol monopropyl ether, methoxymethyl propionate, ethoxyethyl propionate, ethyl cellosolve, ethyl cellosolve acetate, ethyl lactate, ethyl pyruvinate, methyl amyl ketone, cyclohexanone, xylene, toluene, acetone, butyl acetate, tetrahydrofuran, ethyl acetate, nitrobenzene, anisole, dimethylformamide, dimethyl sulfoxide, acetonitrile, chloroform, dichloromethane, dichloroethane, and dichlorobenzene. These solvents may be used alone or in combination.

Next, the raw material liquid is irradiated with light and/or heated to cause a cycloaddition reaction to produce a cyclized compound. When the raw material liquid is irradiated with light, a [4+4] cyclized compound is produced. When the raw material liquid is heated, a [4+2] cyclized compound is produced. When both irradiation with light and heating are performed, a mixture of a [4+4] cyclized compound and a [4+2] cyclized compound is produced.

Thereby, a solution in which the solvent dissolves the cyclized compound, i.e., the cycloaddition product of the first compound and the second compound, or a solution in which the solvent dissolves the cyclized compound, i.e., the intramolecular cycloaddition product of the fourth compound, is obtained.

Next, the resultant solution is applied onto a substrate to form a liquid layer.

The material and shape of the substrate are not particularly limited. A base plate on which another layer or a film pattern is formed may be used as the substrate. Specific examples of materials for the substrate include various types of plastics, SiO₂ (glass), Au, Al, Si, Ta, and Ni.

The application method of the solution is not particularly limited, and any related art or known liquid application method may be used. For example, a spin-coating method or an ink-jet method may be used. In particular, in order to form a film with a predetermined thickness in a predetermined region, the ink-jet method is preferably employed because the application position, the application area, and the application amount can be controlled for each dot. In particular, in order to form a uniform film in a large area, the spin-coating method is preferably employed.

Next, the resultant liquid layer is irradiated with light and/or heated to cause a ring opening reaction in the cyclized compound contained in the liquid layer, and the solvent is removed. Thereby, the liquid layer is solidified and a solid layer (film) is obtained.

The conditions for irradiation with light and heating are set so that the ring opening reaction is caused in the cyclized compound contained in the liquid layer and the first compound and the second compound, or the fourth compound, contained in the raw material liquid are produced.

When the cyclized compound contained in the liquid layer is a [4+4] cyclized compound, in order to cause a ring opening reaction in the cyclized compound, irradiation with light may be performed, heating may be performed, or both irradiation with light and heating may be performed. On the other hand, when the cyclized compound contained in the liquid layer is a [4+2] cyclized compound, in order to cause a ring opening reaction in the cyclized compound at least heating must be performed.

When both the first compound and the second compound contained in the raw material liquid are insoluble in a solvent, or the fourth compound is insoluble in a solvent, the solid composed of the first compound and the second compound, or the solid composed of the fourth compound, is easily precipitated by the ring opening reaction of the cyclized compound. Therefore, the ring opening reaction may be caused by irradiation with light only. After the precipitation, by removing the solvent as necessary, the solid layer is obtained.

On the other hand, when at least one of the first compound and the second compound contained in the raw material liquid is soluble in a solvent, or when the fourth compound is soluble in a solvent, some of the compounds produced by the ring opening reaction are not precipitated by irradiation with light only. Therefore, preferably, the ring opening reaction is caused by irradiation with light and/or heating while the solvent is distilled off by heating.

### [EXAMPLES]

Specific examples are described below to clarify the advantageous effects of the present invention.

### (Example 1)

First, toluene was used as a solvent, and 6,13-dibutoxypentacene represented by structural formula (i), both as a first compound and as a second compound, was dispersed therein to prepare a raw material liquid. 6,13-dibutoxypentacene was insoluble in the solvent. The concentration of 6,13-dibutoxypentacene in the solvent was 1% by mass.

The raw material liquid was irradiated with light of 366 nm while being stirred, and thereby, the product was completely dissolved in the solvent.

The compound dissolved in the resultant solution was identified by NMR, MS, and IR as the cyclized compound represented by structural formula (ii).

The solution obtained by the irradiation with light was applied onto a glass substrate using an ink-jet device to form a liquid layer.

The resultant liquid layer was irradiated with light of 313 nm, and thereby, a solid was precipitated in the liquid layer.

The precipitated solid was identified by MS and absorption spectrum analysis as 6,13-dibutoxypentacene represented by structural formula (i).

The liquid layer was then heated at 100° C. for 2 hours to remove the solvent. Thereby, the liquid layer was solidified, and a film was formed on the substrate.

### (Example 2)

First, toluene was used as a solvent, and the compound represented by structural formula (iii), as a fourth compound, was dispersed therein to prepare a raw material liquid. The compound was insoluble in the solvent. The concentration of the fourth compound in the solvent was 1% by mass.

The raw material liquid was irradiated with light of 366 nm while being stirred, and thereby, the product was completely dissolved in the solvent.

The compound dissolved in the resultant solution was identified by NMR, MS, and IR as the cyclized compound represented by structural formula (iv).

The solution obtained by the irradiation with light was applied onto a glass substrate using an ink-jet device to form a liquid layer.

The resultant liquid layer was irradiated with light of 313 nm, and thereby, a solid was precipitated in the liquid layer.

The precipitated solid was identified by MS and absorption spectrum analysis as the compound represented by structural formula (iii).

The liquid layer was then heated at 100° C. for 2 hours to remove the solvent. Thereby, the liquid layer was solidified, and a film was formed on the substrate.

As described above, in accordance with the examples of the present invention, it was possible to form films composed of acene compounds which are insoluble in solvents by the liquid-phase process using the ink-jet method. The acene compounds used in the examples have semiconductor properties, and the examples are useful for forming organic semiconductor films.

What is claimed is:

1. A film formation method, comprising:
applying at least one of light and heat to a first compound represented by formula (I) and a second compound represented by formula (II) to produce a cyclized compound by way of cycloaddition of the first compound and the second compound;
placing a liquid layer containing the cyclized compound and a solvent which can dissolve the cyclized compound on a substrate; and
applying at least one of light and heat to the liquid layer to produce a solid containing the first compound and the second compound: 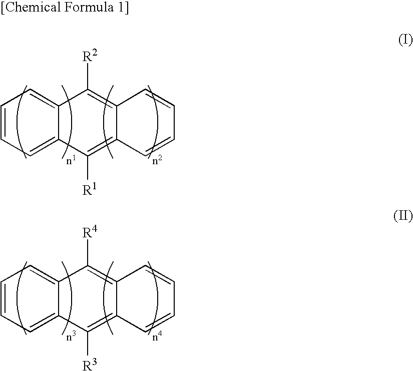
(R¹, R², R³, and R⁴, which may be the same or different, each having an atomic number of 1 to 18, and each containing at least one atom or moiety selected from a group A including a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety; the hydrogen atoms in the benzene nuclei may be substituted; each of n¹, n², n³, and n⁴ being an integer of 0 or more; and at least one of n¹+n² and n³+n⁴ being 2 or more).

2. The film formation method according to claim 1, the cyclized compound being represented by formula (III): 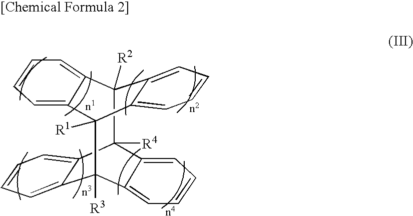
(R¹, R², R³, and R⁴, which may be the same or different, each having an atomic number of 1 to 18, and each containing at least one atom or moiety selected from a group A including a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety; the hydrogen atoms in the benzene nuclei may be substituted; each of n¹, n², n³, and n⁴ being an integer of 0 or more; and at least one of n¹+n² and n³+n⁴ being 2 or more).

3. A film formation method, comprising:
applying at least one of light and heat to a fourth compound represented by formula (IV) to produce a cyclized compound by way of intramolecular cycloaddition of two types of aromatic moieties in the fourth compound;
placing a liquid layer containing the cyclized compound and a solvent which can dissolve the cyclized compound on a substrate; and
applying at least one of light and heat to the liquid layer to produce a solid containing the fourth compound: 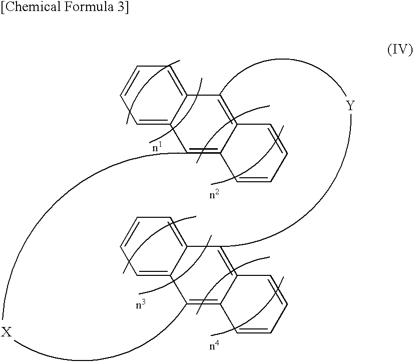
(X and Y, which may be the same or different, each having an atomic number of 2 to 18, and each containing at least one atom or moiety selected from a group A including a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety; the hydrogen atoms in the benzene nuclei may be substituted; each of n¹, n², n³, and n⁴ being an integer of 0 or more; and at least one of n¹+n² and n³+n⁴ being 2 or more).

4. The film formation method according to claim 3, the cyclized compound being represented by formula (V): 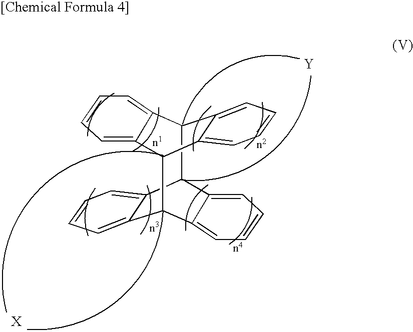
(X and Y, which may be the same or different, each having an atomic number of 2 to 18, and each containing at least one atom or moiety selected from a group A including a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety; the hydrogen atoms in the benzene nuclei may be substituted; each of n¹, n², n³, and n⁴ being an integer of 0 or more; and at least one of n¹+n² and n³+n⁴ being 2 or more).

5. A raw material liquid, comprising:
a first compound represented by formula (I);
a second compound represented by formula (II); and
a solvent: 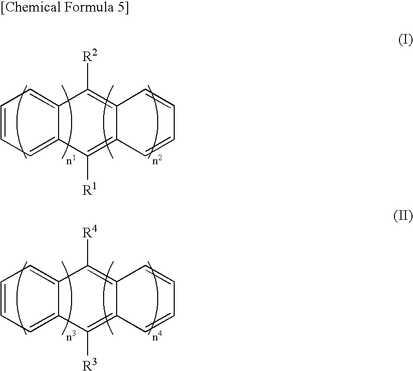
(R¹, R², R³, and R⁴, which may be the same or different, each having an atomic number of 1 to 18, and each containing at least one atom or moiety selected from a group A including a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety; the hydrogen atoms in the benzene nuclei may be substituted; each of n¹, n², n³, and n⁴ being an integer of 0 or more; and at least one of n¹+n² and n³+n⁴ being 2 or more).

6. A raw material liquid, comprising:
a fourth compound represented by formula (IV); and
a solvent: 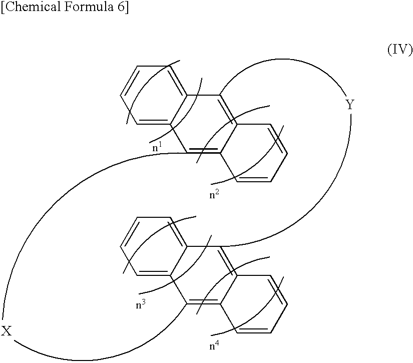
(X and Y, which may be the same or different, each having an atomic number of 2 to 18, and each containing at least one atom or moiety selected from a group A including a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety; the hydrogen atoms in the benzene nuclei may be substituted; each of n¹, n², n³, and n⁴ being an integer of 0 or more; and at least one of n¹+n² and n³+n⁴ being 2 or more).

7. A solution, comprising:
a cyclized compound produced by the cycloaddition of a first compound represented by formula (I);
a second compound represented by formula (II); and
a solvent which can dissolve the cyclized compound: 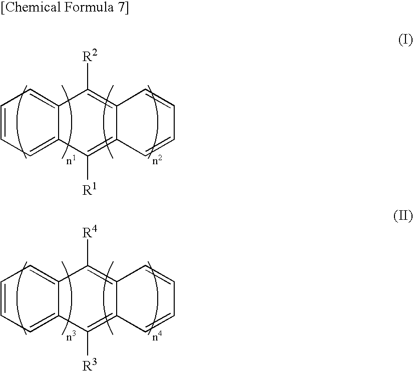
(R¹, R², R³, and R⁴, which may be the same or different, each having an atomic number of 1 to 18, and each containing at least one atom or moiety selected from a group A including a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety; the hydrogen atoms in the benzene nuclei may be substituted; each of n¹, n², n³, and n⁴ being an integer of 0 or more; and at least one of n¹+n² and n³+n⁴ being 2 or more).

8. The solution according to claim 7, the cyclized compound being represented by formula (III): 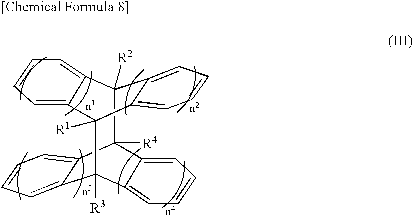
(R¹, R², R³, and R⁴, which may be the same or different, each having an atomic number of 1 to 18, and each containing at least one atom or moiety selected from a group A including a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety; the hydrogen atoms in the benzene nuclei may be substituted; each of n¹, n², n³, and n⁴ being an integer of 0 or more; and at least one of n¹+n² and n³+n⁴ being 2 or more).

9. A solution, comprising:
a cyclized compound produced by the intramolecular cycloaddition of a fourth compound represented by formula (IV); and
a solvent which can dissolve the cyclized compound: 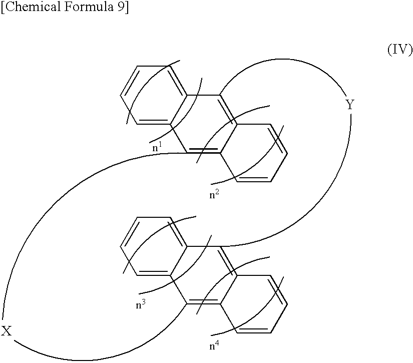
(X and Y, which may be the same or different, each having an atomic number of 2 to 18, and each containing at least one atom or moiety selected from a group A including a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety; the hydrogen atoms in the benzene nuclei may be substituted; each of n¹, n², n³, and n⁴ being an integer of 0 or more; and at least one of n¹+n² and n³+n⁴ being 2 or more).

10. The solution according to claim 9, the cyclized compound being represented by formula (V): 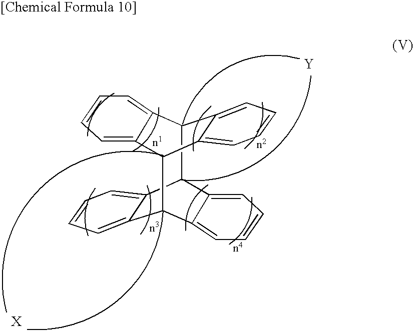
(X and Y, which may be the same or different, each having an atomic number of 2 to 18, and each containing at least one atom or moiety selected from a group A including a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety; the hydrogen atoms in the benzene nuclei may be substituted; each of n¹, n², n³, and n⁴ being an integer of 0 or more; and at least one of n¹+n² and n³+n⁴ being 2 or more).

11. A cyclized compound produced by the cycloaddition of a first compound represented by formula (I) and a second compound represented by formula (II) by the action of at least one of light and heat: 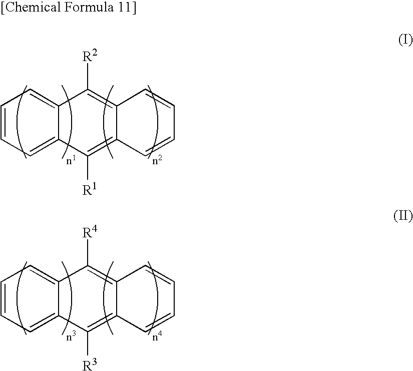
(R¹, R², R³, and R⁴, which may be the same or different, each having an atomic number of 1 to 18, and each containing at least one atom or moiety selected from a group A including a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety; the hydrogen atoms in the benzene nuclei may be substituted; each of n¹, n², n³, and n⁴ being an integer of 0 or more; and at least one of n¹+n² and n³+n⁴ being 2 or more).

12. A cyclized compound represented by formula (III): 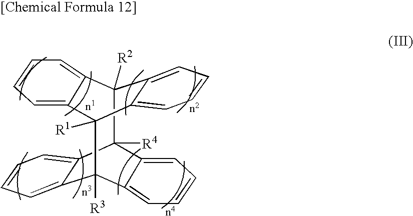
(R¹, R², R³, and R⁴, which may be the same or different, each having an atomic number of 1 to 18, and each containing at least one atom or moiety selected from a group A including a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety; the hydrogen atoms in the benzene nuclei may be substituted; each of n¹, n², n³, and n⁴ being an integer of 0 or more; and at least one of n¹+n² and n³+n⁴ being 2 or more).

13. A cyclized compound produced by the intramolecular cycloaddition of a fourth compound represented by formula (IV) by the action of at least one of light and heat: 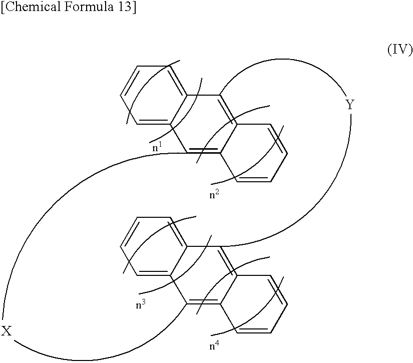
(X and Y, which may be the same or different, each having an atomic number of 2 to 18, and each containing at least one atom or moiety selected from a group A including a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety; the hydrogen atoms in the benzene nuclei may be substituted; each of n¹, n², n³, and n⁴ being an integer of 0 or more; and at least one of n¹+n² and n³+n⁴ being 2 or more).

14. A cyclized compound represented by formula (V): 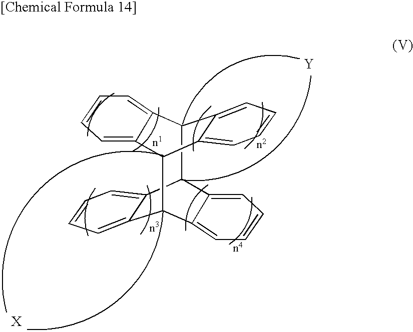
(X and Y, which may be the same or different, each having an atomic number of 2 to 18, and each containing at least one atom or moiety selected from a group A including a hydrogen atom, a halogen atom, an alkane moiety, an alkene moiety, an ether moiety, an acetal moiety, a carbonyl moiety, an amino moiety, an amide moiety, an ester moiety, a carbonate ester moiety, an imide moiety, and an acid anhydride moiety; the hydrogen atoms in the benzene nuclei may be substituted; each of n¹, n², n³, and n⁴ being an integer of 0 or more; and at least one of n¹+n² and n³+n⁴ being 2 or more).

15. A method for forming an organic semiconductor film, comprising:
using the film formation method according to claim 1.

16. A method for fabricating a semiconductor device, comprising:
using the method for forming an organic semiconductor film according to claim 15.
